(19) United States
(12) Patent Application Publication
(10) Pub. No.: US 2026/0030530 A1
(43) Pub. Date: Jan. 29, 2026

(54) RECOMMENDATION FROM AMONG A MULTIPLICITY OF OPTIONS WITH REASONING USING GENERATIVE ARTIFICIAL INTELLIGENCE

(71) Applicant: Roku, Inc., San Jose, CA (US)

(72) Inventors: Vinay Gopal SHETTY, Santa Clara, CA (US); Ricardo VASQUEZ-SIERRA, San Jose, CA (US); Pranav MATHUR, San Jose, CA (US); Caiyi CHEN, Fremont, CA (US)

(73) Assignee: Roku, Inc., San Jose, CA (US)

(21) Appl. No.: 18/782,844

(22) Filed: Jul. 24, 2024

(51) Int. Cl. G06N 5/045; G06N 3/0475

(52) U.S. Cl. CPC G06N 5/045; G06N 3/0475

(57) ABSTRACT

Disclosed herein are system, apparatus, article of manufacture, method and/or computer program product embodiments, and/or combinations and sub-combinations thereof, for recommendation from among a plurality of options with reasoning using generative artificial intelligence (AI). An example embodiment operates by receiving a natural-language textual request for a recommendation from among a plurality of options based on one or more criteria. A natural-language textual prompt is generated based on the request. The prompt references context data comprising the options. The prompt and context data is provided to a generative AI model, which provides an output that includes a textual description uniquely specifying a chosen one of the plurality of options, a numeric value scoring the chosen one of the plurality of options, and a natural-language textual justification for choosing the chosen one of the plurality of options. The textual justification generated by the generative AI model is based on the textual prompt and the context data.

### BACKGROUND

### Field

This disclosure is generally directed to automated recommendations, and more particularly to recommendation from among a multiplicity of options with reasoning using generative artificial intelligence (“generative AI”).

### SUMMARY

Provided herein are system, apparatus, article of manufacture, method and/or computer program product embodiments, and/or combinations and sub-combinations thereof, for audience segment recommendation with reasoning using large language models.

An example embodiment operates by receiving a natural-language textual request for a recommendation from among a plurality of options based on one or more criteria. A natural-language textual prompt is generated based on the request. The prompt references context data comprising the options. The prompt and context data is provided to a generative AI model, which provides an output that includes a textual description uniquely specifying a chosen one of the plurality of options, a numeric value scoring the chosen one of the plurality of options, and a natural-language textual justification for choosing the chosen one of the plurality of options. The textual justification generated by the generative AI model is based on the textual prompt and the context data.

### BRIEF DESCRIPTION OF THE FIGURES

The accompanying drawings are incorporated herein and form a part of the specification.

FIG. 1 is a block diagram of a system for recommendation from among a multiplicity of options with reasoning using generative AI, according to some embodiments.

FIG. 2 is a Venn diagram illustrating example subsets of a universe of items, which subsets may be options to be recommended from.

FIG. 3 is a flow diagram of a method for recommendation from among a multiplicity of options with reasoning using generative AI, according to some embodiments.

FIG. 4 is a flow diagram of an example method of reducing the size of context data supplied to a generative AI so that it satisfies a context data token limit.

FIG. 5 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for automatically making one or more recommendations from among a multiplicity of options and providing automatically generated natural-language reasoning text explaining the one or more recommendations using generative artificial intelligence (AI) systems and techniques, such as one or more large language models (LLMs).

The systems, methods, and non-transitory computer-readable media described herein can assist in choosing from among a multiplicity of known options having known attributes by automatically choosing one or more of the options and providing natural-language reasoning text that explains why the chosen one or more options represent a reasoned choice from among the multiplicity of options. The systems, methods, and non-transitory computer-readable media described herein can make use of generative AI natural language models to generate the natural-language reasoning text. The systems, methods, and non-transitory computer-readable media described herein thus offer a technical improvement over existing tools for interacting with options for selection, such as a data management platform (DMP) that can only provide access to information useful for analyzing and selecting options available for selection. A DMP can include a database and a user interface (e.g., a web-based graphical user interface) used to access, navigate, analyze, and/or manipulate the database. The database can include one or more tables listing the options available for selection and information about the options useful for informing the selection.

A DMP may provide a pool of option information that is too large for an entity (a “chooser”) seeking to choose an option to quickly and effectively navigate, analyze, and understand. As an example, the number of options available for browsing within a DMP can be in the thousands or millions, and options may be granularized, named, and described within a DMP in ways that may make the options and their relevance, viability, or preferability difficult for a chooser to comprehend. For example, an option may be granularized, named, and described within a DMP in a way that does not make clear that the option may, in fact, be relevant, viable, or preferable for selection. A chooser may have difficulty understanding or articulating why a particular option is relevant, viable, or preferable and should be selected. As another example, finding one or more most relevant, viable, or preferable options for selection among thousands or millions of possible options may be too time-consuming to be practicable. As the number of options or option features proliferates and the granularity of options or option features increases, the technological problem of option selection using a DMP can progressively worsen until it is intractable by conventional DMP usage methods.

Various embodiments of the systems, methods, and non-transitory computer-readable media described herein can improve the functioning of computer systems and/or the technical fields of option selection and audience segment targeting. As one example, various embodiments provide enhanced identifying, targeting, and distribution of content to audience segments. The systems, methods, and non-transitory computer-readable media described herein can reducing analysis time needed to identify and select viable, relevant, or preferable options (e.g., audience segments). Various embodiments also provide other technical improvements beyond reducing the analysis time. As one example, various embodiments can convert a subjective process for identification and targeting of audience segments into a consistent, repeatable, and predictable objective process. Different human users using traditional tools, such as a DMP, to analyze options in order to make a recommendation may ultimately recommend different options (e.g., audience segments) and/or may articulate different reasoning behind selecting the options, and may even recommend as many different options (e.g., audience segments) or articulate as many different rationales as there are human users set to the task of making the recommendation. By contrast, the methods employed in the present description, including generating a detailed natural-language textual prompt and providing the prompt to a generative AI model, can lead to repeatability and consistency in option selection and accompanying rationale articulation. The systems, methods, and non-transitory computer-readable media described herein therefore effect an improvement in technology or technical field, specifically automated option selection and generation of accompanying natural-language articulated reasoning for making the selection. Embodiments described herein can efficiently and effectively generate, capture, and store natural-language articulated reasoning for a selection whereas existing techniques are unable to do so. Moreover, as described below, various embodiments improve computers by reducing the number of computer processing cycles required of a generative AI to generate a recommendation result, reducing network congestion, reducing memory utilization requirements, and improving result generation response time, among other technical benefits. Various embodiments reduce the number of options or features that the generative AI analyzes, thus reducing computational costs, network congestion, and memory usage, among other technical improvements.

As an example, the systems, methods, and non-transitory computer-readable media described herein can assist in choosing from among a multiplicity of audience segment options. Each audience segment option can have a descriptive name and can have associated with it one or more features (e.g., attributes), each of which may have a numerical index value. The systems, methods, and non-transitory computer-readable media described herein can assist in choosing by automatically choosing one or more of the audience segment options and providing natural-language reasoning text that explains why the chosen one or more audience segment options represent a reasoned choice from among the multiplicity of audience segment options. For example, the systems, methods, and non-transitory computer-readable media described herein can assist in choosing by automatically choosing one or more of the audience segment options by analyzing features associated with the one or more of the audience segment options to determine that the features are relevant to the goals of the targeting, choosing the relevant features, and providing natural-language reasoning text that explains why each of the chosen features represents a reasoned choice from among the multiplicity of audience segment option features. The selection of one or more audience segment options can then be based on the chosen features.

Information about audiences of media, such as streaming media, including movies, television shows, short-form videos, videos games, and other content, can be collected for improved targeting of media, including other streaming media and advertising media, to the audiences. The data collection may be done, for example, by a content distributor, such as a streaming media distributor. Individual audience members from among the general audience population may be grouped into segments based on the collected data. The segmentation can be by demographic information (e.g., age, gender, geographical location) and categories as may be determined from collected media consumption history data, voluntary poll responses, search data collected from audience members, purchase history data collected from audience members, and other audience information sources, or combinations of these. The categories may be representative or audience member preferences or other audience member attributes.

A media content provider (a “targeter”) seeking to target one or more particular audience segments for dissemination of targeted media to the one or more targeted audience segments may seek useful information about the audience segments, in order to make informed choices about which segment(s) to target or to conduct evaluation of an effectiveness of a targeted campaign, as examples. For a given audience segment, this segment information may include, as examples, a textual description of the audience segment, the size of the segment in terms of number of audience members or the percentage of the general audience as a whole, statistics (e.g., demographic statistics) about the makeup of the segments, and the types and/or sources of data that have gone into informing the segmentation. Having selected one or more audience segments to target, the targeter can communicate targeted segment choices to a content distributor, which can then distribute the targeted media to audience members of the one or more targeted audience segments based on the communicated targeted segment choices.

A DMP can provide access to information useful for analyzing and selecting audience segments available for targeting. However, a DMP may provide a pool of audience segment information that is too large for a targeter to quickly and effectively navigate, analyze, and understand. For example, the number of segments or segment features available for browsing within a DMP can be in the thousands or millions, and segments can be granularized, named, and described in ways that may make the segments, and their relevance to a target audience, difficult for a human user of a DMP to understand. As an example, an audience segment may be granularized, named, and described in a way that does not make clear that the audience segment may, in fact, be relevant for targeting with particular targeted media. A targeter may have difficulty understanding or articulating why a particular audience segment is relevant and should be selected for targeting in view of the media to be targeted. As another example, finding one or more most relevant audience segments for targeting among thousands or millions of possible audience segments may be too time-consuming to be practicable. As the number and granularity of audience segments proliferates, the technological problem of targeted segment selection using a DMP may be expected to progressively worsen until it is intractable by conventional DMP usage methods.

The demographic features can include various ethnicities, presence of children in the household, marital status, education, income, interests (e.g., pet ownership, outdoor activities, and home activities such as cooking, gardening, decorating, home improvement), cultural or artistic interests, career interests, sports interests, fashion interests, current affairs or politics interests, lifestyle attributes (e.g., savvy investors, frequent travelers, empty nesters), age, and gender, as but a few examples. Other features can relate to counts of users and/or devices associated with an account or household, usages of various platforms, affinities for various content types or genres, and usage time spent consuming content (e.g., broken down by type and/or genre), to name but a few examples.

Thus, for a targeter, navigating a large pool of information in a DMP to find a relevant audience segment can be overwhelming and time-consuming. Even when a targeter makes audience segment selections in a DMP, it may be difficult to readily understand or articulate the reasoning behind the selections when reviewed. It is therefore an objective of the systems, methods, and computer-readable media described herein to simplify the process, from the human user perspective, of analyzing audience segment information (in a DMP or otherwise) to recommend one or more appropriate audience segments. It is further an objective of the systems, methods, and computer-readable media described herein to provide clearly articulated natural-language reasoning that explains why segments recommended for selection fit within specific segment targeting parameters and thus are likely to meet the specific segment targeting needs of the targeter.

In some embodiments, the systems, methods, and computer-readable media described herein use generative AI, such as one or more LLMs, to analyze data available from a DMP database including, for example, indexing scores and such attributes as demographic attributes and streaming behavior (e.g., preferences) attributes. The systems, methods, and computer-readable media can thus generate targeted recommendations (e.g., targeted audience segment recommendations) and further can provide detailed justifications for each recommendation. For example, by integrating one or more LLMs, the systems, methods, and computer-readable media can analyze and synthesize the vast array of demographic and behavioral data stored in a DMP database, ensuring that each recommendation is data-driven and is closely aligned with a targeter's audience segment targeting objectives. The systems, methods, and computer-readable media can use one or more LLMs such as OpenAI's generative pre-trained transformer 4 (GPT-4®) or GPT-4 Omni (GPT-40™) to process audience segment attributes to produce smart recommendations, improving precision in identifying and targeting audience segments. This precision can improve targeter reach of targeted content to specifically defined audience groups, resulting in higher engagement and conversion rates.

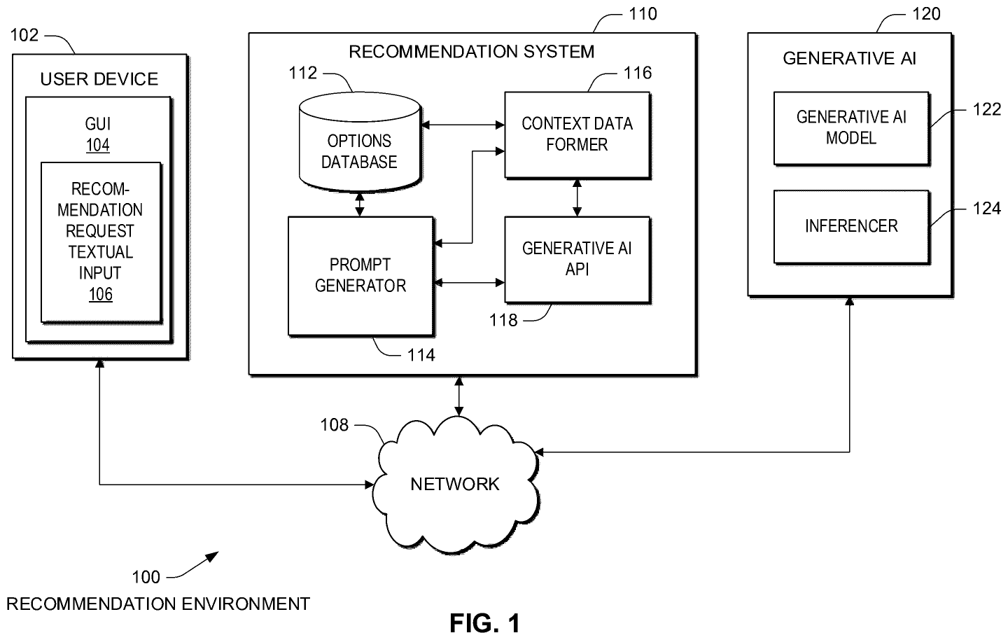

Various embodiments of this disclosure may be implemented using and/or may be part of a recommendation environment 100 shown in FIG. 1. It is noted, however, that recommendation environment 100 is provided solely for illustrative purposes, and is not limiting. Embodiments of this disclosure may be implemented using and/or may be part of environments different from and/or in addition to the recommendation environment 100, as will be appreciated by persons skilled in the relevant art(s) based on the teachings contained herein. An example of the recommendation environment 100 shall now be described.

### Recommendation Environment

The block diagram of FIG. 1 illustrates a recommendation environment 100, according to some embodiments. The recommendation environment 100 may include one or more instances of a user device 102, which can be any computing device capable of accepting inputs from and providing outputs to a user, such as a desktop computer, a laptop computer, a mobile device (e.g., smart phone or tablet), or a special-purpose computing device. The user device 102 can provide a user interface, such as a graphical user interface (GUI) 104, which can include a recommendation request textual input 106. The recommendation request textual input 106 can accept a natural-language textual request for a recommendation from among a plurality of options entered into the GUI 104, e.g., by typing the textual request, or by transcribing into the textual input 106 a spoken request. For example, a neural network model can be used to perform speech-to-text transcription to convert the spoken request into the textual request in the textual input 106.

The user device can transmit the natural-language textual request for a recommendation to the recommendation system 110. In some examples, and as shown in FIG. 1, the recommendation system may be executed using a different computer system than the user device 102, such as a server or a cloud-based computer system, and the natural-language textual request for a recommendation may be transmitted to the recommendation system 110 via a network 108, such as the internet or an intranet. In other examples, the recommendation system 110 can be executed from the user device 102, and the user device 102 may transmit the natural-language textual request for a recommendation directly to the recommendation system 110 without an intervening network 108. In various embodiments, the network 108 can include, without limitation, wired and/or wireless intranet, extranet, the internet, cellular, Bluetooth, infrared, and/or any other short range, long range, local, regional, global communications mechanism, means, approach, protocol and/or network, as well as any combination(s) thereof.

The recommendation system 110 can include, or can be communicatively coupled to, an options database 112. The options database can include one or more tables storing various options to be chosen from. The recommendation system 110 can further include a prompt generator 114. The prompt generator can be configured to generate a natural-language textual prompt, suitable for provision to a generative AI model 122, based on the natural-language request received from the recommendation request textual input 106. In some examples, the textual prompt can include a directive instructing the generative AI model 122 to provide its output in tabular format. The textual prompt can reference context data, which can also be provided to the generative AI model along with the textual prompt, for use in inferencing to provide an output of a selection of one or more options from the options database 112. The context data can include all or some of the options from the options database 112. The recommendation system 110 can further include a context data former 116. The context data former can be configured with logic that can select a subset of the options from the options database 112 as the context data, and/or can compress the context data from the options or the subset of the options, so that the context data is within input token limits and/or file upload size limits of the generative AI model 122. The recommendation system 110 can further include a generative AI application programming interface (API) 118. The generative AI API 118 can properly form requests for transmission to a generative AI 120 that includes the generative AI model 122, based on the prompt provided by the prompt generator 114 and context data as provided by the context data former 116. The generative AI API 118 can also specify how the generative AI 120 can provide its output back to the recommendation system 110 and/or the user device 102. Recommendation system 110 may include more than one generative AI API 118. For example, recommendation system 110 may include a different generative AI API 118 for each different type of generative AI 120 that may be used by recommendation system 110. In this way, the recommendation system 110 may be configured to be model-agnostic, in that it may be configurable use different generative AI models 122 to generate recommendations.

The options database 112 may include one or more tables listing options to be selected from by recommendation system 110. The options database 112 may, as examples, be a relational database, a non-relational database, a data repository, a data lake, a flat file such as a comma-separated values (CSV) file, a spreadsheet, or any other suitable data store. In some examples, individual rows of a table of the options database 112 are not unique options, but are, instead, attributes of options, such that any single option may occupy multiple rows of a table. In other examples, options may be stored in a first table of the database 112 and option attributes may be stored in a second table of the database 112.

In some examples, the recommendation system 110 can be used for making recommendations between different audience segments, and the options database 112 can include tables or lists of different audience segments. The segmented audience can be, as examples, an audience of subscription video on demand (SVOD) users, an audience of advertising-based video on demand (AVOD) users, an audience television on demand (TVOD) users, an audience of game users, or an audience of subscription software users. Content provided by a content provider (e.g., a streaming content provider) may include any combination of music, videos, movies, TV programs, multimedia, images, still pictures, text, graphics, gaming applications, advertisements, programming content, public service content, government content, local community content, software, and/or any other content or data objects in electronic form.

The options database 112 can, for example, consist of a mix of first-party and third-party data, where first-party data is generated by a content provider and third-party data is sourced from another data provider. Where it can be determined that there is an individual or household match between entries in the first-party data and entries in the third-party data, the first-party data and the third-party data entries may be merged to create more detailed data. For example, the first-party data may contain content preferences information about what content an individual audience member or household prefers to consume. This content preferences information may come from records about content directly accessed by audience members using the services of the content provider, and/or may come from automatic content recognition (ACR) features of a device in a household of an audience member. The ACR can recognize (e.g., by listening using a microphone, or watching using a video camera, or by fingerprinting displayed video and comparing to a fingerprint database) content (TV shows, movies, video games, etc.) consumed by the audience member even though this content is not supplied by the content provider. As examples, ACR can generated data used to determine whether an audience member watches linear (non-streaming) TV, what kind of linear TV the audience member watches, and/or whether the audience member plays video games (e.g., non-streaming video games) using gaming console, for example, and what types of video games the audience member plays. Other content preferences information available in first-party data may include information about how audience members consume content (e.g., on TVs, on personal computers, on mobile phones, on tablets), how much they consume content (e.g., number of minutes per month, e.g., broken down by content type or genre), and what kind of content they watch (e.g., is an audience member an action movie lovers, a comedy lover, a drama lover, a viewer of a content from a particular streaming service or network). Each of these attributes can be used to segment the audience and thus generate different audience segments in the options database 112. Third-party data may contain, for example, information about individual or household income or demographics that is supplementary to the first-party data. Merging the features (attributes) from the third-party data and into records from the first-party data can be used to create richer options data in the options database 112 that can permit for more granular audience segmentation by different features (attributes).

Each option in the options database 112 can include, for example, a unique textual description and a numeric value scoring the option. For example, each attribute for audiences inside a segment may be scored. For example, each score may be a numeric value scoring how well the attribute, for a particular segment, indexes against the same attribute when compared to the population of users as a whole. The score may thus meaningfully represent how much members in a segment have an affinity towards the attribute in relation to the whole audience. As one example, a score for an “outdoor activities lovers” attribute may advise that a particular audience segment is 45% more likely to enjoy outdoor activities than the audience as a whole. As another example, a “true crime content lovers” attribute may score higher for the segment “women in their 40s” than it would for “children age five and under.” The scoring for various attributes in a segment, as may be stored in the options database 112 and provided as part of context data to a generative AI model 122, may thus help determine what is special about a segment, and thus may be useful information in determining whether the segment is appropriate for targeting, and in allowing the generative AI model 122 to articulate a justification for selecting the segment.

After the generative AI API 118 of the recommendation system 110 formats a request, including a prompt generated by the prompt generator 114 and the context data sourced from the options database 112 and prepared by the context data former 116, the recommendation system 110 can transmit the formatted request to a generative AI 120 via the network 108. In some examples, the generative AI 120 may be executed using the same computer system used to execute the recommendation system 110, in which case the formatted request can be transmitted without the network 108 as an intermediary. Examples of the generative AI 120 can include Google Gemini 1.5 Pro, OpenAI GPT-4 or GPT-40, and Anthropic Claude 3. GPT-4 is based on eight models with 220 billion parameters each, for a total of about 1.76 trillion parameters, connected by a mixture of experts (MoE). GPT-40 has a token limit of 128,000 tokens. Gemini 1.5 Pro has 1.5 trillion parameters and a token limit of 1,000,000 tokens. A token limit may dictate the combined size of both an input (including prompt and context data) and an output of the generative AI 120. Accordingly, an input token limit, if not directly specified by the generative AI 120, may be estimated or determined based on the anticipated maximum token length of an output of the generative AI 120. An input token limit may restrict the size of an input to the generative AI 120 and thus may limit the amount of context data that can be provided as part of the request to the generative AI 120. Accordingly, context data former 116 can be configured to provide a subset of the options in the options database 112 (e.g., a subset of the multiplicity of audience segments in the options database 112) rather than all of the options (e.g., rather than all of the audience segments), and/or may compress the options or options subset (e.g., using a vector store) as the context data, so that the combined token length of the prompt and the context data provided to the generative AI 120 as an input does not exceed a specified, estimated, or determined input token limit of the generative AI 120.

The generative AI 120 may receive the request, including the prompt and the context data, from the recommendation system 110. The generative AI 120 can include the generative AI model 122 and associated algorithms and/or routines used to operate the model 122 to generate outputs, labeled in FIG. 1 as inferencer 124. For example, the inferencer 124 can use the generative AI model 122 (e.g., an LLM) to generate recommendations from among possible options supplied in the context data. The inferencer 124 can further use the generative AI model 122 to generate a natural-language textual justification for choosing a recommended option. For example, the textual justification can articulate, in natural language, reasoning why a particular audience segment would make a relevant, viable, or preferable choice for targeting, based on the textual prompt and the context data. For example, the textual justification can note one or more numerical scores for one or more attributes of a recommended audience segment, which scores can, as described above, be indicative of what makes the recommended audience segment special in comparison to the audience as a whole or in comparison to other similar segments. In some examples, the generative AI 120 can include, or the generative AI model 122 can comprise, multiple machine learning models that can work together or can provide different functions. For example, one such model 122 can be an LLM that generates textual output, and another model 122 of the generative AI 120 can be an image generation model than generates visual outputs such as pictures, charts, or graphs.

The generative AI 120 can transmit the output of the generative AI model 122 to the GUI 104 of the user device 102, or to the recommendation system 110, which can, in turn, forward the output to the user device 102. The user device 102 can display the output of the generative AI model 122 to the user (e.g., chooser or targeter), who can review the selected options of the output and make a decision based on the selected options and the included textual justification for each selected option. In some examples, the recommendation system 110 can be configured to automatically format the output of the generative AI model 122 as a slideshow presentation. As one example, the prompt generator 114 of the recommendation system 110 can instruct the generative AI model 122 to generate a slideshow presentation and to format its options selections as slides of the slideshow presentation. The output of the generative AI 120 can then be received as the slideshow presentation. As another example, the recommendation system 110 can receive textual output from the generative AI model 122, and can supply the textual output as input back into the generative AI 120 or a different generative AI 120 with a directive in a new prompt to format the textual output as a slideshow presentation. As an example, the slideshow presentation can format the textual data as graphical depictions, such as charts or graphs, and/or may generate pictorial visual illustrations using image generation capabilities of the generative AI model 122. The slideshow presentation can be used to propose the selected option or options to a human decision-maker during a pitch meeting, for example.

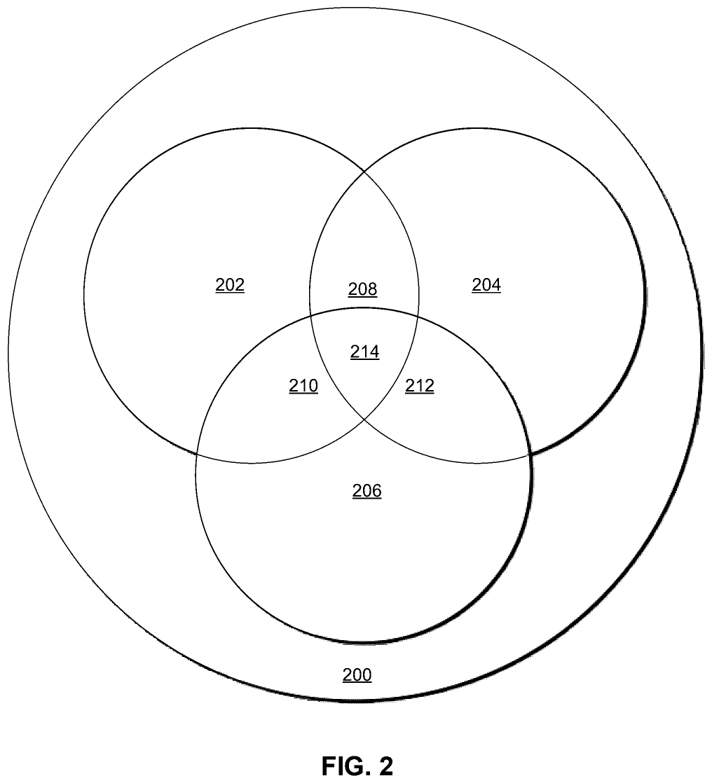

The Venn diagram of FIG. 2 illustrates example segmentation of a universe of items. In the Venn diagram of FIG. 2, the largest circle 200 represents all items in the universe of items. Upper-left circle 202 represents a first subset of the items in the universe. Upper-right circle 204 represents a second subset of the items in the universe. Lower circle 206 represents a third subset of the items in the universe. Upper lens 208 represents a fourth subset of items in the universe that is an intersection of the first and second subsets. Lower-left lens 210 represents a fifth subset of items in the universe that is an intersection of the first and third subsets. Lower-right lens 212 represents a sixth subset of items in the universe that is an intersection of the second and third subsets. Rouleaux triangle 214, in the middle of the diagram, represents a seventh subset of items in the universe that is an intersection of the first, second, and third subsets 202, 204, 206, or, equivalently, an intersection of the fourth, fifth, and sixth subsets 208, 210, 212, among other combinations. An intersection of unique subsets always results in smaller subsets. The items in the Venn diagram of FIG. 2 can be, for example, audience members, such that any of the subsets 202, 204, 206, 208, 210, 212, 214 are audience segments.

In examples where options database 112 contains audience segments, a first subset 202 may be, for example, the audience segment “credit card users,” a second subset 204 may be the audience segment “people residing in New York City,” and a third subset 206 may be the segment “audience members who watch shows about Asian cuisine.” The seventh subset 214 may therefore be an appropriate target for notifications, advertising, or offers pertaining to a New York City-based Chinese delivery restaurant that accepts advance credit card payment for orders. As another example where options database 112 contains audience segments, a first subset 202 may be the audience segment “women in their 30s,” a second subset 204 may be the audience segment “people with incomes above $50,000 a year,” and a third subset 206 may be the segment “audience members who watch shows about physical fitness.” The seventh subset 214 may therefore be an appropriate target for notifications, advertising, or offers pertaining to an upscale women's exercise clothing company or store. New, more specific audience segments may be generated as combinations of existing audience segments and saved to options database 112, thus resulting in the proliferation of audience segments in the options database 112, such that the number of stored segments can reach the thousands or millions. Recommendation system 110 may also be configured to generate new segments by combining two or more recommended segments as may be recommended by recommendation system 110 using generative AI 120. Combinations of segments can result in smaller, but more precisely targeted segments. New segments generated by recommendation system 110 can be saved to options database 112 and used in making future recommendations. This new segment generation can result in a multiplicity of audience segments stored in the options database 112 such that the number of stored segments may become too large to practically comprehend or query to determine which segment or segments may be most relevant, viable, or preferable for precise audience segment targeting.

### Recommendation Method

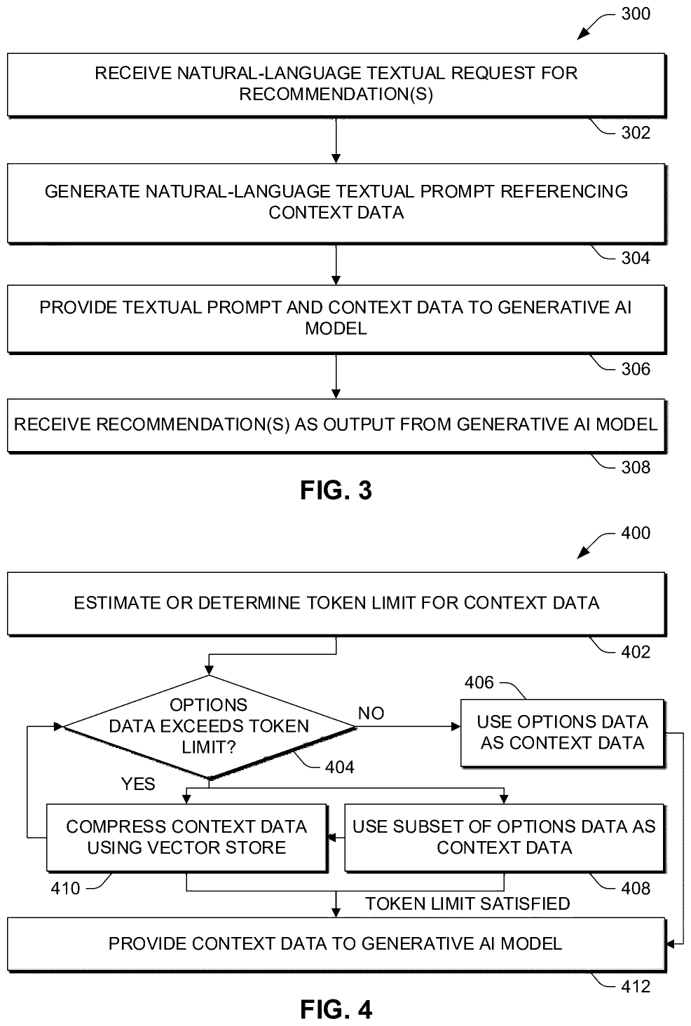

FIG. 3 is a flow diagram for a method 300 for recommendation from among a multiplicity of options with reasoning using generative AI, according to some embodiments. Method 300 can be performed by processing logic that can comprise hardware (e.g., circuitry, dedicated logic, programmable logic, microcode, etc.), software (e.g., instructions executing on a processing device), or a combination thereof. Not all steps may be needed to perform the disclosure provided herein. Further, some of the steps may be performed simultaneously, or in a different order than shown in FIG. 3, as will be understood by a person of ordinary skill in the art.

Method 300 is described with reference to FIG. 3. However, method 300 is not limited to that example embodiment, and, in some examples, may incorporate other methods or method components, such as the method 400 of FIG. 4.

In method 300, recommendation system 110 can receive 302 from a user device 102 a natural-language textual request for one or more recommendations from among a plurality of options. Each of the plurality of options can be represented, for example, as a data element of an options database or file. In some examples, each option of the plurality of options is an audience segment representing a subset of users of a streaming media service. The textual request can be a simple one- or two-sentence request indicating the intent of the recommendation request, such as, “A maker of widgets wants to launch an ad campaign on our content delivery service. Which segment do you recommend?” This example request thus can be understood (e.g., by a generative AI model 122) to specify at least one criterion for making the recommendation: the advertisements to be targeted are for widgets. Thus, the natural-language textual request can, in some examples, include an entity, product, or service that can serve as the at least one criterion. Prompt generator 114 can generate 304 a natural-language textual prompt based on the natural-language request. For example, prompt generator 114 can use a script to generate the prompt based on (e.g., including verbatim) the natural-language request. The natural-language textual prompt thus generated 304 can reference context data. In some examples, the natural-language textual prompt thus generated 304 can be engineered to include, as examples, a role assignment, a data attributes overview describing elements of the context data, a description of the desired decision-making process, an output format directive, and/or an example output to an example input. The context data can include, for example, a multiplicity of options (e.g., audience segments) to be chosen from as the sought-after recommendation. The context data can comprise the options, a subset of the options, or data compressed from the options or the subset of the options.

The recommendation system 110 can provide 306 the textual prompt and the context data to a generative AI model 122 (e.g., an LLM). The recommendation system 110 or the user device 102 can receive 308, from the generative AI model 122, an output of the generative AI model 122. The output can include, for example, a textual description uniquely specifying a chosen one of the plurality of options, a numeric value scoring the chosen one of the plurality of options, and a natural-language textual justification for choosing the chosen one of the plurality of options. The natural-language textual justification can be generated by the generative AI model 122 based on the natural-language textual prompt and the context data. For example, where the chosen one of the plurality of options is a chosen audience segment, the natural-language textual justification for choosing the chosen one of the plurality of options can include a natural-language explanation linking the entity, product, or service included in the natural-language textual request to the chosen audience segment. In some examples, each audience segment has associated with it, in the options database or file, one or more features and one or more scores each associated with a corresponding one of the one or more features. Each of the one or more scores can quantify a representation of the corresponding one of the one or more features within the audience segment compared to prevalence of the one of the corresponding one or more features across a general audience of users of the streaming media provider service. In some examples, the natural-language textual prompt generated by the prompt generator 114 can include a directive to provide the output in tabular format. The output can therefore be received, at least in part, as one or more rows of a table, each of the one or more rows of the table including, for a recommended option of a corresponding row, a unique set of the textual description, the numeric value, and the natural-language textual justification. An example output table is given in Table 1.

TABLE 1
EXAMPLE TABULAR OUTPUT

| | Indexing % | | |
|---|---|---|---|
| | against | | |
| | generic | | |
| | AVOD | Base | |
| Feature | streamers | metric | Justification for relevance |
| Technology | 14.6% | 34,762,760 | Targets consumers interested in the |
| Enthusiasts | | | latest technology, aligning with the |
| | | | widget maker's product range |
| Business and | 24.44% | 4,622,890 | Attracts professionals and businesses, |
| Finance | | | relevant for widget solutions |
| Video Game | 8.54% | 14,940,230 | Appeals to the gaming community, |
| Players | | | suitable for promoting widget consoles |
| | | | and games |
| Computer/Software | 13.69% | 9,841,210 | Directly targets consumers likely to |
| Frequent Spenders | | | purchase or upgrade their computer |
| | | | software, relevant for widget products |

Table 1 provides a scored list of recommended features (attributes), but not necessarily a single recommended audience segment. The output can further include a name or other unique identifier of a recommended targeted audience segment that ranks highly for one or more of the recommended features (attributes), preferably for a plurality of the recommended features, more preferably for a majority of the recommended features, and most preferably for all of the recommended features. The output can further include one or more additional names or other unique identifiers of other recommended targeted audience segments, providing a short list of options for a human decision-maker to choose from. In some examples, the output can recommend a logical intersection (merging) of two or more relevant segments to provide one or more new, more precisely targeted segments not previously offered as options in the options database 112. The one or more new, more precisely targeted segments can be added in to the options database 112, increasing the number of available segments and enlarging the options database 112.

### Context Data Token Limit Satisfaction Method

FIG. 4 is a flow diagram for an example method 400 for reducing the size of context data supplied to a generative AI 120 so that it satisfies a context data token limit of the generative AI 120. Method 400 can be performed by processing logic that can comprise hardware (e.g., circuitry, dedicated logic, programmable logic, microcode, etc.), software (e.g., instructions executing on a processing device), or a combination thereof. Not all steps may be needed to perform the disclosure provided herein. Further, some of the steps may be performed simultaneously, or in a different order than shown in FIG. 4, as will be understood by a person of ordinary skill in the art.

Method 400 is described with reference to FIG. 4. However, method 400 is not limited to that example embodiment, and, in some examples, may incorporate other methods or method components, such as the method 300 of FIG. 3.

In method 400, recommendation system 110 can estimate or determine 402 a token limit for context data. The token limit for context data TL_{context} can, for example, be estimated or determined as TL_{context}=TLₜₒₜₐₗ−T_{output_expected}−Tₚᵣₒₘₚₜ, where TLₜₒₜₐₗ is the total token limit of the generative AI model 122 (including both input to and output of the model), Tₚᵣₒₘₚₜ is the token size of the prompt generated by the prompt generator 114, and T_{output_expected} is a size (e.g., a maximize size), in tokens, of an expected output of the generative AI model 122, estimated or determined in view of the particular recommendation application and the inputs involved. For example, T_{output_expected} can be estimated or determined heuristically, by executing inferencing of the generative AI model 122 a number of times using example prompts and example context data, and basing T_{output_expected} on the largest output (e.g., by adding a percentage, such as 10% or 15%, of the largest output token size to the largest output token size as a padding, and choosing the resultant number as T_{output_expected}).

The recommendation system 110 can then compare 404 the size of the options data as stored in options database 112, or a selected subset of the options data, to the context data token limit TL_{context}. Based on the options data or the selected subset of the options data not exceeding the context data token limit, the recommendation system 110 can use 406 the compared 404 entirety or subset of the options data as the context data to provide, along with the prompt, as the input to the generative AI model 122.

Based, however, on the options data or the selected subset of the options data exceeding the estimated or determined context data token limit, the recommendation system 110 can (i) pare down 408 the options data or subset thereof to a still smaller subset of the options data to use as the context data to provide, along with the prompt, as the input to the generative AI model 122. In some examples, the paring 408 can be based on logic that eliminates likely irrelevant options, such as little-used options. In an example where the options comprise audience segments, the paring 408 can include, for example, culling options coded to be unrelated to the application in the textual request, which can be coded by keyword, for example. In some examples, the paring 408 can be based on logic that sorts the options in the options database 112 by some criteria and returns a limited list of top results of the sort operation.

Additionally or alternatively, the recommendation system 110 can (ii) compress 410 the options data or subset thereof, used as the context data, using vector store. Vector store, also known as vector datastore, encodes domain-specific data as a set of elements, each expressed internally as a vector containing a set of numeric values across a set of dimensions, mapping elements in relation to each other in a multi-dimensional vector space, with proximity between semantic vector elements becoming an indicator for contextual relationship. The clustering of options data from the options database 112 such that related features are closer to each other can have the effect of substantially reducing the overall size of the context data, in effect compressing the context data. Vectorization of context data can be performed, for example, by a pre-trained language model such as BERT (bidirectional encoder representations from transformers), GPT (generative pre-trained transformer), or any other model that can generate embeddings to convert the context data into vector representations. These vector representations can be stored in a vector store that optimized for handling and searching high-dimensional vectors. Then, when the generative AI model 122 uses the context data, it can perform a similarity search within the vector store. The most relevant context vectors are found based on their cosine similarity or other distance metrics.

As indicated in FIG. 1, the method 400 can perform one or both of the (i) paring 408 and the (ii) vector store compression 410 before again checking whether the performed context data size reduction operations have satisfied the context data token limit. If not, one or both of the context data size reduction operations 408, 410 can be repeated until the context data token limit is satisfied. Based on the data token limit being satisfied, the recommendation system 110 can provide 412 the context data (along with the prompt) as input to the generative AI model 122. The provision 412 of the model of method 400 can, accordingly be a part of the providing 306 the input to the generative AI model 122 of method 300 in FIG. 3. Method 400 has the benefits and advantages of reducing the number of computer processing cycles required of the generative AI 120 to generate a recommendation result, reducing network congestion, reducing memory utilization requirements, and improving result generation response time, among other technical benefits.

In some examples, the generative AI model 122 can be configured to be capable of retrieval-augmented generation (RAG), and can access context data from the options database 112 on an as-needed basis, which can be another way of circumventing context data token limitations, and/or can be used in combination with vector store methods. For example, the RAG-enabled generative AI model 122 can select only the most pertinent data rather than operating on the entire dataset in the options database 112. The RAG-enabled generative AI model 122 can, for example, propose names of relevant features (attributes), and then search the options database 112 for features that are named identically or similar to the AI's proposed feature names. This relevance limiting reduces the number of options or features that the AI would ultimately analyze, thus reducing computational costs, network congestion, and memory usage, among other benefits.

In still other examples, the generative AI model 122 can be provided with another one or more layers that are trained on the options information in the options database 112. In such examples, no context data needs to be provided with the input to the generative AI model 122, because the generative AI model 122 already incorporates the options information as part of its training.

### Prompt Engineering

The prompt generator 114 can be configured to use principles of prompt engineering to generate a detailed natural-language prompt, based on the natural-language textual request entered via the recommendation request textual input 106 of the user device 102, to use as input to the generative AI model 122. Prompt engineering can ground generative AI inferencing in a domain-specific context to appropriately scope the spectrum of semantic meaning to the request domain, use a specified form of analysis, format the inferencing output as desired, improve result accuracy, reduce AI hallucinations, and increase result reproducibility so that same or similar results are returned with multiple instances of inferencing based on the same inputs. Because a generative AI model infers a next token based on a set of input tokens and previous output tokens, the contextual relevance and specificity of the input can determine the likelihood that the next token inferred is also contextually relevant and specific, and therefore that the output as a whole is meaningful and valid.

As an example, the prompt generator 114 can be configured to engineer (precisely generate) the prompt to include one or more of a role assignment, a data attributes overview describing elements of the context data, a description of the desired decision-making process, an output format directive, and/or an example output to an example input. The role assignment can comprise a statement assigning a role to the generative AI 120, e.g., “You are an advanced audience segment recommender bot.” The role assignment can further include detailed information about the intended functioning and intended output of the generative AI 120 in the context of being assigned the role of recommender bot, such as a directive to “analyze a dataset that includes various audience segments characterized by unique identifiers” and/or “show the result in a table.” An example format for the table, or a link to a template providing such an example format, can be provided in the prompt as generated by the prompt generator 114.

The data attributes overview of the prompt can describe elements of the context data. In the example where the context data contains audience segment information, the data attributes overview can include, for example, natural-language descriptions describing the meaning of different fields or columns of the context data, such as “base segment data” (unique identifier, such as a name), “features” (attributes, the textual names of which are not segments for recommendation, but are data points used to make a decision), “feature buckets” (textual names of groupings of attributes), and “indexing percent” (a metric quantifying the representation of a feature within a segment compared to its prevalence across the general audience as a whole, where a positive indexing percent signals that a feature is more common in the segment than in the audience as a whole, suggesting overrepresentation, a negative indexing percent points to underrepresentation, and a value close to zero indicates parity with the audience as a whole).

The description of the desired decision-making process of the prompt can include directives for how data analysis is to be performed, such as directives for “assessing each segment” according to some relevant given criteria, or “focusing on” certain specified features as specified in the engineered prompt. The description of the desired decision-making process of the prompt can further include one or more directives for relevance evaluation, such as instructions to determine how closely features and their respective indexing percentages align with goals stated in or implied by the natural-language textual request input by the user. The description of the desired decision-making process of the prompt can further include one or more directives for selection of options, e.g., audience segment recommendation based on the analysis. These directives can include, for example, a directive to include details on demographics, behaviors, or other standout characteristics that make the recommended segments particularly appealing.

The output format directive of the prompt can direct the generative AI model 122 to provide its output in a specific format, e.g., including a table, or formatted as a slideshow presentation. The output format directive may also contain a reference (or another reference) to the context data supplied to the LLM along with the prompt, e.g., specifying that the context data is comma separated data (CSV format), or some other provided format.

The example output to the example input portion of the engineered prompt can include an example user query input (e.g., an example natural-language textual request different from the actual natural-language textual request entered by the user into the recommendation request textual input 106) and an example output for this example input. As an example, the example output supplied as part of the engineered prompt can include an example introductory paragraph, an example recommended option (e.g., a unique name or other identifier of the option), example information about the example recommended option (e.g., a number of households, in the example that the recommended option is an audience segment), an example table with details (e.g., of selected attributes, e.g., in the form of Table 1 herein), an example overall justification for the example recommended option, and an example conclusion paragraph. As another example, where the desired output is a slideshow presentation, the example output can be an example slideshow presentation uploaded as a file to the generative AI model 122. The example slideshow presentation can include some or all of the above example output information, formatted as a slideshow presentation with example pictures, charts, and/or graphs, as may be desired.

### Example Computer System

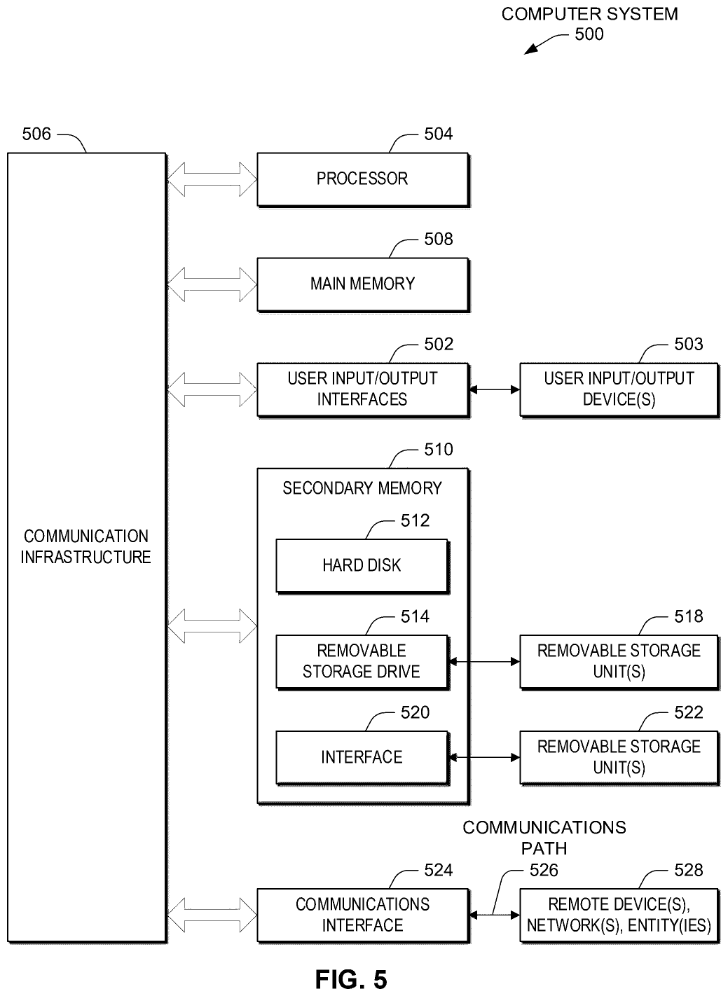

Various embodiments may be implemented, for example, using one or more well-known computer systems, such as computer system 500 shown in FIG. 5. For example, the user device 102, the recommendation system 110, and/or the generative AI 120 may be implemented using combinations or sub-combinations of computer system 500. Also or alternatively, one or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU), a tensor processing unit (TPU), or an AI processing unit (AIPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In an embodiment, a TPU may have a parallel structure that is efficient for parallel processing tensors. In an embodiment, a TPU may have a parallel structure that is efficient for parallel processing AI data, such as inputs and weights of a neural network model.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premises” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

### CONCLUSION

The automation of segment identification and the generation of recommendations offered by the systems, methods, and computer-readable media described herein can significantly reduce the time needed to analyze data and make targeting decisions, freeing computing resources, such as processing cycles and memory, for other tasks. The improved efficiency further allows marketing teams to focus on strategy and creative development rather than data analysis. The automation of segment identification and the generation of recommendations offered by the systems, methods, and computer-readable media described herein improves data-driven decision making can use robust data analytics to empower campaign managers to make decisions based on comprehensive insights. The data-driven approach of the systems, methods, and computer-readable media can reduce guesswork and can enhance the strategic planning of campaigns. The automation of segment identification and the generation of recommendations offered by the systems, methods, and computer-readable media described herein can more accurately target audience segments to help targeters improve the return on investment (ROI) of content targeting campaigns. Improved targeting leads to more effective targeting spending, higher conversion rates, and increased revenue.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for recommendation from among a plurality of options, the computer-implemented method comprising:
receiving, by at least one computer processor, a natural-language textual request for a recommendation from among the plurality of options based on one or more criteria in the natural-language textual request, wherein each of the plurality of options is represented as a data element of an options database or file;
generating a natural-language textual prompt based on the natural-language textual request, the natural-language textual prompt referencing context data comprising the plurality of options, a subset of the plurality of options, or data compressed from the plurality of options or the subset of the plurality of options;
providing the natural-language textual prompt and the context data to a generative artificial intelligence (AI) model;
receiving, from the generative AI model, an output comprising:
a textual description uniquely specifying a chosen one of the plurality of options;
a numeric value scoring the chosen one of the plurality of options or a feature of the chosen one of the plurality of options; and
a natural-language textual justification for choosing the chosen one of the plurality of options, the natural-language textual justification generated by the generative AI model based on the natural-language textual prompt and the context data.

2. The computer-implemented method of claim 1, wherein:
each option of the plurality of options is an audience segment representing a subset of users of a streaming media provider service,
the chosen one of the plurality of options is a chosen audience segment,
the natural-language textual request includes an entity, product, or service, and
the natural-language textual justification for choosing the chosen one of the plurality of options includes a natural-language explanation linking the entity, product, or service to the chosen audience segment.

3. The computer-implemented method of claim 2, wherein:
each audience segment has associated with it, in the options database or file, one or more features and one or more scores each associated with a corresponding one of the one or more features, and
each of the one or more scores quantifies a representation of the corresponding one of the one or more features within the audience segment compared to prevalence of the one of the corresponding one or more features across a general audience of users of the streaming media provider service.

4. The computer-implemented method of claim 1, wherein:
the natural-language textual prompt includes a directive to provide the output at least in part in a tabular format,
the output comprises one or more rows of a table, and
each of the one or more rows of the table comprises, for a recommended option of a corresponding row, a unique set of the textual description, the numeric value, and the natural-language textual justification.

5. The computer-implemented method of claim 1, wherein:
the natural-language textual prompt includes a directive to provide the output at least in part in a tabular format,
the context data comprises features of the plurality of options,
the output comprises one or more rows of a table, and
each of the one or more rows of the table comprises, for a recommended feature of a corresponding row, a unique set of:
a textual description of the recommended feature;
a numeric value scoring the recommended feature; and
a natural-language textual justification for choosing the recommended feature that is distinct from the natural-language textual justification for choosing the chosen one of the plurality of options.

6. The computer-implemented method of claim 5, wherein the natural-language textual justification for choosing the chosen one of the plurality of options is based on the one or more recommended features in the table.

7. The computer-implemented method of claim 1, further comprising, before the providing the natural-language textual prompt and the context data to the generative AI model:
estimating or determining a context data token limit based on a token limit of the generative AI model; and
based on determining that the context data comprising the plurality of options exceeds the context data token limit, at least one of:
providing the subset of the plurality of options as the context data; or
providing the data compressed from the plurality options or the subset of the plurality of options as the context data using a vector store technique for representing the plurality of options.

8. A system, comprising:
one or more memories; and
at least one processor each coupled to at least one of the memories and configured to perform operations comprising:
receiving a natural-language textual request for a recommendation from among a plurality of options based on one or more criteria in the natural-language textual request, wherein each of the plurality of options is represented as a data element of an options database or file;
generating a natural-language textual prompt based on the natural-language textual request, the natural-language textual prompt referencing context data comprising the plurality options, a subset of the plurality of options, or data compressed from the plurality of options or the subset of the plurality of options;
providing the natural-language textual prompt and the context data to a generative artificial intelligence (AI) model;
receiving, from the generative AI model, an output comprising:
a textual description uniquely specifying a chosen one of the plurality of options;
a numeric value scoring the chosen one of the plurality of options or a feature of the chosen one of the plurality of options; and
a natural-language textual justification for choosing the chosen one of the plurality of options, the natural-language textual justification generated by the generative AI model based on the natural-language textual prompt and the context data.

9. The system of claim 8, wherein:
each option of the plurality of options is an audience segment representing a subset of users of a streaming media provider service,
the chosen one of the plurality of options is a chosen audience segment,
the natural-language textual request includes an entity, product, or service, and
the natural-language textual justification for choosing the chosen one of the plurality of options includes a natural-language explanation linking the entity, product, or service to the chosen audience segment.

10. The system of claim 9, wherein:
each audience segment has associated with it, in the options database or file, one or more features and one or more scores each associated with a corresponding one of the one or more features, and
each of the one or more scores quantifies a representation of the corresponding one of the one or more features within the audience segment compared to prevalence of the one of the corresponding one or more features across a general audience of users of the streaming media provider service.

11. The system of claim 8, wherein:
the natural-language textual prompt includes a directive to provide the output at least in part in a tabular format,
the output comprises one or more rows of a table, and
each of the one or more rows of the table comprises, for a recommended option of a corresponding row, a unique set of the textual description, the numeric value, and the natural-language textual justification.

12. The system of claim 8, wherein:
the natural-language textual prompt includes a directive to provide the output at least in part in a tabular format,
the context data comprises features of the plurality of options,
the output comprises one or more rows of a table, and
each of the one or more rows of the table comprises, for a recommended feature of a corresponding row, a unique set of:
a textual description of the recommended feature;
a numeric value scoring the recommended feature; and
a natural-language textual justification for choosing the recommended feature that is distinct from the natural-language textual justification for choosing the chosen one of the plurality of options.

13. The system of claim 12, wherein the natural-language textual justification for choosing the chosen one of the plurality of options is based on the one or more recommended features in the table.

14. The system of claim 8, wherein the operations further comprise, before the providing the natural-language textual prompt and the context data to the generative AI model:
estimating or determining a context data token limit based on a token limit of the generative AI model; and
based on determining that the context data comprising the plurality of options exceeds the context data token limit, at least one of:
providing the subset of the plurality of options as the context data; or
providing the data compressed from the plurality of options or the subset of the plurality of options as the context data using a vector store technique for representing the plurality of options.

15. A non-transitory computer-readable medium having instructions stored thereon that, when executed by at least one computing device, cause the at least one computing device to perform operations comprising:
receiving a natural-language textual request for a recommendation from among a plurality of options based on one or more criteria in the natural-language textual request, wherein each of the plurality of options is represented as a data element of an options database or file;
generating a natural-language textual prompt based on the natural-language textual request, the natural-language textual prompt referencing context data comprising the plurality of options, a subset of the plurality of options, or data compressed from the plurality of options or the subset of the plurality of options;
providing the natural-language textual prompt and the context data to a generative artificial intelligence (AI) model;
receiving, from the generative AI model, an output comprising:
a textual description uniquely specifying a chosen one of the plurality of options;
a numeric value scoring the chosen one of the plurality of options or a feature of the chosen one of the plurality of options; and
a natural-language textual justification for choosing the chosen one of the plurality of options, the natural-language textual justification generated by the generative AI model based on the natural-language textual prompt and the context data.

16. The non-transitory computer-readable medium of claim 15, wherein:
each option of the plurality of options is an audience segment representing a subset of users of a streaming media provider service,
the chosen one of the plurality of options is a chosen audience segment,
the natural-language textual request includes an entity, product, or service, and
the natural-language textual justification for choosing the chosen one of the plurality of options includes a natural-language explanation linking the entity, product, or service to the chosen audience segment.

17. The non-transitory computer-readable medium of claim 15, wherein:
each audience segment has associated with it, in the options database or file, one or more features and one or more scores each associated with a corresponding one of the one or more features, and
each of the one or more scores quantifies a representation of the corresponding one of the one or more features within the audience segment compared to prevalence of the one of the corresponding one or more features across a general audience of users of the streaming media provider service.

18. The non-transitory computer-readable medium of claim 15, wherein:
the natural-language textual prompt includes a directive to provide the output at least in part in a tabular format,
the output comprises one or more rows of a table, and
each of the one or more rows of the table comprises, for a recommended option of a corresponding row, a unique set of the textual description, the numeric value, and the natural-language textual justification.

19. The non-transitory computer-readable medium of claim 15, wherein:
the natural-language textual prompt includes a directive to provide the output at least in part in a tabular format,
the context data comprises features of the plurality of options,
the output comprises one or more rows of a table, and
each of the one or more rows of the table comprises, for a recommended feature of a corresponding row, a unique set of:
a textual description of the recommended feature;
a numeric value scoring the recommended feature; and
a natural-language textual justification for choosing the recommended feature that is distinct from the natural-language textual justification for choosing the chosen one of the plurality of options.

20. The non-transitory computer-readable medium of claim 15, wherein the operations further comprise, before the providing the natural-language textual prompt and the context data to the generative AI model:
estimating or determining a context data token limit based on a token limit of the generative AI model; and
based on determining that the context data comprising the plurality of options exceeds the context data token limit, at least one of:
providing the subset of the plurality of options as the context data; or
providing the data compressed from the plurality of options or the subset of the plurality of options as the context data using a vector store technique for representing the options.
